(19) United States
(12) Patent Application Publication
(10) Pub. No.: US 2025/0192277 A1
(43) Pub. Date: Jun. 12, 2025

(54) TRACTION BATTERY PACK LATTICE SYSTEM TO GUIDE THERMAL MANAGEMENT FLUID AND METHOD OF GUIDING THERMAL MANAGEMENT FLUID

(71) Applicant: Ford Global Technologies, LLC, Dearborn, MI (US)

(72) Inventor: Xiaogang Zhang, Novi, MI (US)

(21) Appl. No.: 18/530,867

(22) Filed: Dec. 6, 2023

(51) Int. Cl. H01M 10/6557; H01M 10/613; H01M 10/625; H01M 10/647; H01M 10/653; H01M 10/6567; H01M 50/209; H01M 50/249

(52) U.S. Cl. CPC H01M 10/6557; H01M 10/613; H01M 10/625; H01M 10/647; H01M 10/653; H01M 10/6567; H01M 50/209; H01M 50/249; H01M 2220/20

(57) ABSTRACT

A traction battery pack assembly includes a cell stack within an interior of an enclosure. The cell stack includes a plurality of battery cells disposed along a cell stack axis. The cell stack also includes a lattice system that guides a liquid coolant of an immersion thermal management system within the interior. The liquid coolant manages thermal levels within the interior.

### TECHNICAL FIELD

This disclosure details exemplary systems that guide liquid coolant within a battery pack and, more particularly, to a system that guides the liquid coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: a cell stack within an interior of an enclosure, the cell stack including a plurality of battery cells disposed along a cell stack axis; and a lattice system that guides a liquid coolant of an immersion thermal management system within the interior.

In some aspects, the techniques described herein relate to an assembly, wherein the lattice system includes at least one latticed spacer that is secured directly to at least one of the battery cells.

In some aspects, the techniques described herein relate to an assembly, wherein the lattice system includes at least one latticed spacer that is disposed between axially adjacent battery cells of the cell stack.

In some aspects, the techniques described herein relate to an assembly, wherein the lattice system includes a plurality of latticed spacers, the cell stack including battery cells alternating with the latticed spacers along the cell stack axis.

In some aspects, the techniques described herein relate to an assembly, wherein the lattice system includes at least one latticed spacer having a plurality of first ribs overlaying a plurality of second ribs.

In some aspects, the techniques described herein relate to an assembly, wherein cell stack has a top side, opposing outboard sides, and a bottom side, the plurality of first ribs tilted at a first angle to guide the liquid coolant toward one of the outboard sides, the second ribs tilted at a different, second angle to guide the liquid coolant toward the other one of the outboard sides.

In some aspects, the techniques described herein relate to an assembly, wherein each first rib extends along a respective first rib axis, wherein each second rib extends along a respective second rib axis, the first rib axes offset from the second rib axes about the cell stack axis.

In some aspects, the techniques described herein relate to an assembly, wherein the first rib axes are offset sixty degrees from the second rib axes.

In some aspects, the techniques described herein relate to an assembly, wherein the first ribs are secured directly to a first battery cell within the plurality of battery cells, wherein the second ribs are secured directly to a second battery cell within the plurality of battery cells, the first battery cell directly adjacent to the second battery cell along the cell stack axis.

In some aspects, the techniques described herein relate to an assembly, wherein the first ribs and the second ribs are compressed against each other along the cell stack axis.

In some aspects, the techniques described herein relate to an assembly, wherein the first ribs and the second ribs are a polymer-based material.

In some aspects, the techniques described herein relate to an assembly, wherein the plurality of first ribs are directly secured to the plurality of second ribs.

In some aspects, the techniques described herein relate to an assembly, wherein the lattice system is configured to guide the liquid coolant at a position between axially adjacent battery cells within the plurality of battery cells.

In some aspects, the techniques described herein relate to an assembly, wherein the lattice system includes a least one latticed spacer that is polymer-based.

In some aspects, the techniques described herein relate to an assembly, wherein the cell stack is one of a plurality of cell stacks within the interior.

In some aspects, the techniques described herein relate to an assembly, wherein the liquid coolant is a dielectric liquid coolant.

In some aspects, the techniques described herein relate to a method of managing thermal energy levels within a traction battery pack, including: immersing at least a portion of a cell stack within a liquid coolant to manage thermal energy within the cell stack, the cell stack including a plurality of battery cells disposed along a cell stack axis; and guiding the liquid coolant between battery cells of the cell stack.

In some aspects, the techniques described herein relate to a method, further including guiding the liquid coolant using at least one latticed spacer disposed axially between a first cell within the plurality of battery cells and an axially adjacent second cell within the plurality of battery cells.

In some aspects, the techniques described herein relate to a method, wherein the cell stack including battery cells alternating with the latticed spacers along the cell stack axis.

In some aspects, the techniques described herein relate to a method, wherein the cell stack has an top side and opposing outboard sides, the liquid coolant introduced to areas between the plurality of battery cells through the top side, the liquid coolant guided within the areas toward one of the opposing outboard sides.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1 along with portions of an immersion thermal management system.

FIG. 3 the view of the FIG. 2 with an enclosure assembly removed to show a cell stack of the battery pack.

FIG. 4 illustrates a close up view of an area in FIG. 3.

FIG. 5 illustrates a front view of an example latticed spacer from the cell stack of FIG. 3.

FIG. 6 illustrates a perspective view of a cell from the cell stack of FIG. 3.

FIG. 7 illustrates a flow of a liquid coolant moving through a portion of the latticed spacer of FIG. 5.

### DETAILED DESCRIPTION

An immersion thermal management system can be used to manage thermal energy in a traction battery pack. The immersion thermal management system immerses at least some components of the traction battery pack in a liquid coolant. The immersed components can include a cell stack. This disclosure is directed toward guiding the liquid coolant using a lattice system to facilitate thermal transfer between the liquid coolant and the components of the battery pack, particularly between cells of the cell stack.

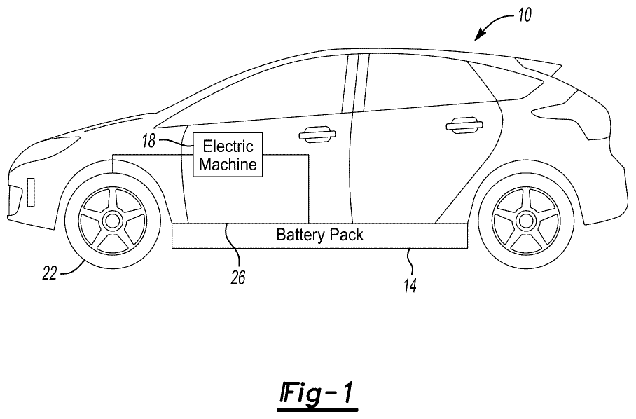

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

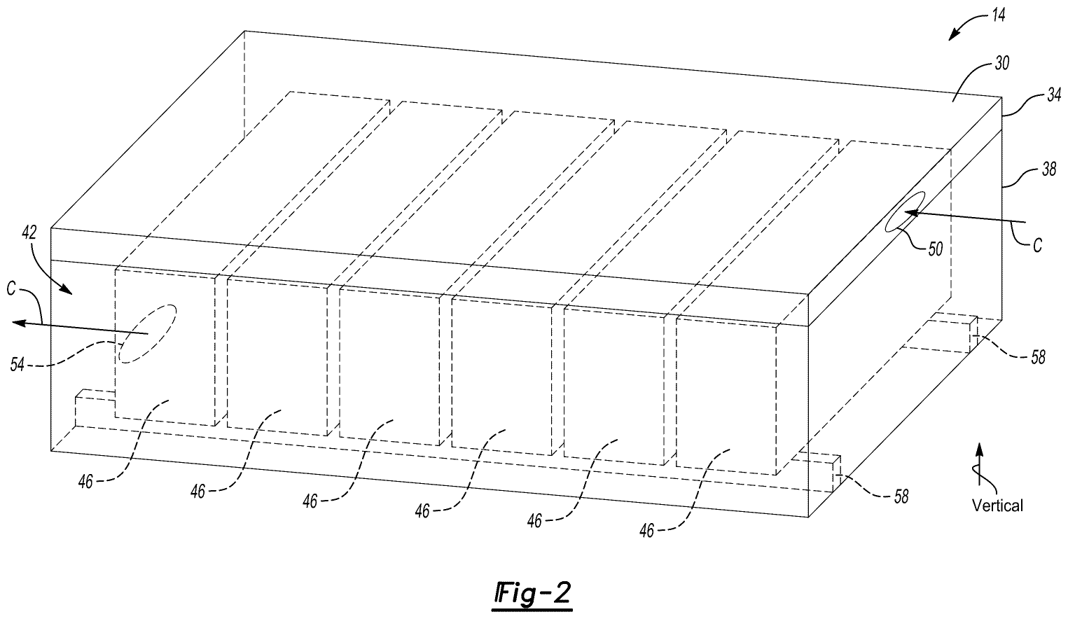

FIG. 2 illustrates additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within the enclosure assembly 30. The cell stack 42 includes a plurality of individual battery cells 46 disposed along a cell stack axis A. The cell stack 42 could include any number of battery cells 46. The battery pack 14 could employ any number of cell stacks 42 within the enclosure assembly 30. Thus, this disclosure is not limited to the exact configuration shown in FIG. 2. Further, while the battery cells 46 of FIG. 2 are positioned side-by-side relative to one another, other configurations are also contemplated within the scope of this disclosure, including but not limited to embodiments in which the battery cells 46 are stacked on top of one another, for example.

In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The cell stack 42 is arranged in an interior of the enclosure assembly 30 within the tray 38 and beneath the cover 34. A thermal management system is used to manage thermal energy levels within the battery pack 14. The example thermal management system is configured to route non-conductive (i.e., dielectric) coolant C over areas of the cell stack 42 to manage thermal energy within the cell stack 42 by, for example, using the coolant C to take on heat from the cell stack 42. the thermal management system is an immersion thermal management system at least because portions of the battery pack 14, here at least the battery cells 46 of the cell stack 42 are immersed in the coolant C.

In this example, the coolant C generally flows from an inlet 50, which is formed in the cover 34, to an outlet 54, which is formed in the tray 38 at an opposite end of the enclosure assembly 30 from the inlet 50. The cell stack 42 can be elevated above a floor of the tray 38 with at least one stand 58 to provide a path for the coolant C to move to the outlet 54.

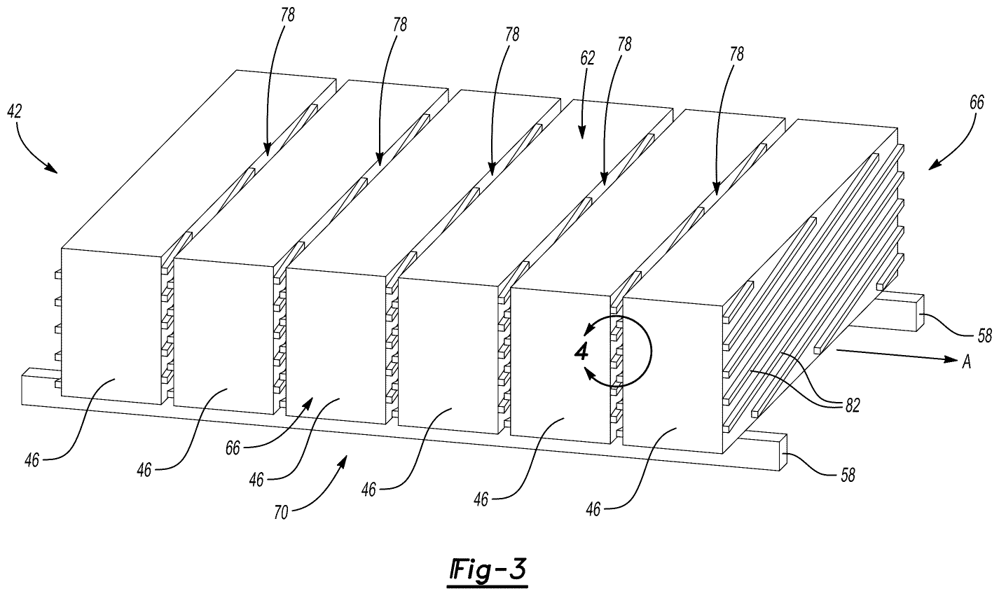

With reference to FIG. 3, the cell stack 42 has a top side 62, opposing outboard sides 66, and a bottom side 70. Within the interior of the enclosure assembly 30, some of the coolant C moves from the cover 34 through the top side 62 of the cell stack 42 and in between the cells 46. Thermal energy can transfer between the coolant and the cells 46 as the coolant C moves between the cells 46. As can be appreciated, increasing a surface area of the cells 46 contacting the coolant C can facilitate thermal energy transfer.

To further facilitate thermal energy transfer, the battery pack 14 includes a lattice system that provides clearance between the cells 46 for the coolant C to move between the cells 46. The lattice system also guides and helps to introduce turbulence within the coolant C as the coolant C passes between the cells 46 of the cell stack 42.

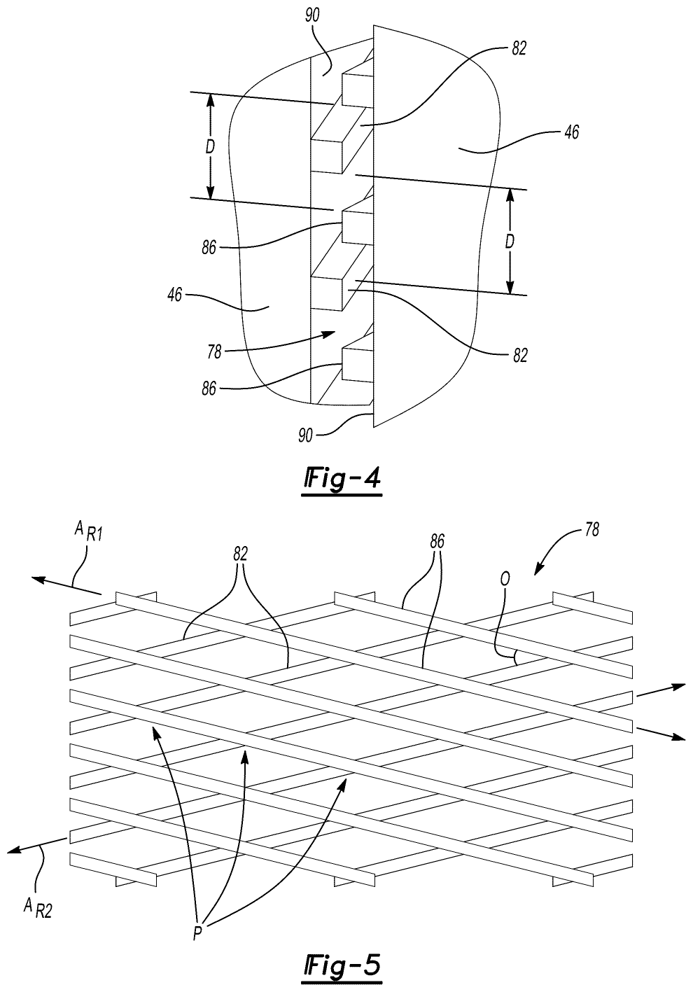

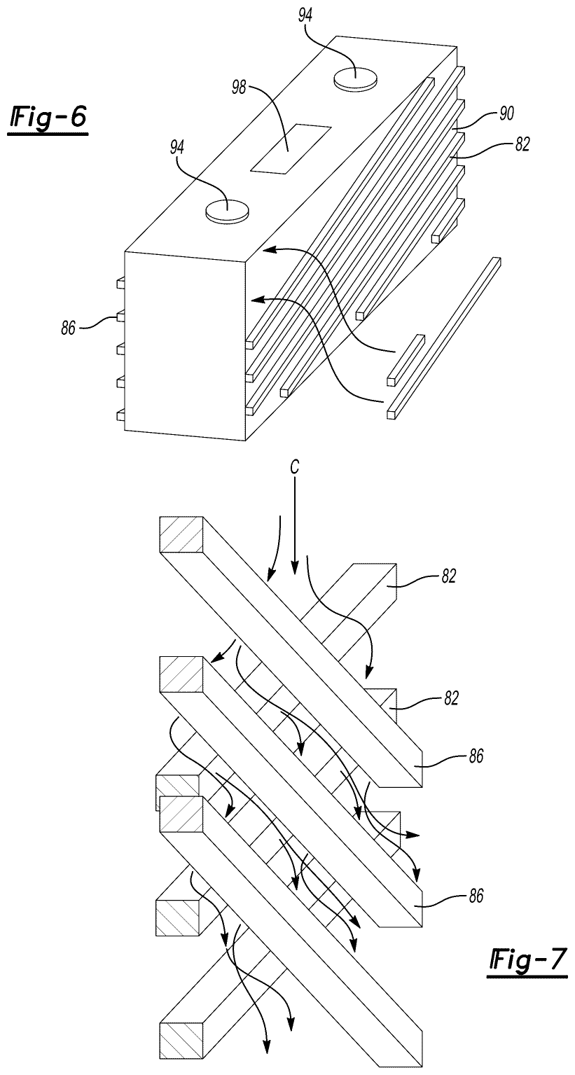

With reference now to FIGS. 4-7 and continuing reference to FIGS. 2 and 3, the lattice system includes at least one latticed spacer 78 that is secured directly to at least one of the cells 46. In this example, one of the latticed spacers 78 is disposed between each of the axially adjacent cells 46 in the cell stack 42. The cells 46 and latticed spacers 78 alternate along the axis A.

The example latticed spacers 78 each include a plurality of first ribs 82 attached to one of the cells 46 and a plurality of second ribs 86 attached to an axially adjacent one of the cells 46. The first ribs 82 and the second ribs 86 could be secured to respective cells 46 using adhesive, for example. The first ribs 82 overlay the second ribs 86 within the cell stack 42. In this example, the first ribs 82 and the second ribs 86 are about one millimeter thick and about one millimeter wide. A distance D between the ribs is about two millimeters in this example.

The first ribs 82 each extend longitudinally along a respective first rib axis AR1. The second ribs 86 each extend longitudinally along a respective second rib axis AR2. The first rib axes AR1 are offset by an angle O from the second rib axes AR2 about the cell stack axis A, which extends perpendicular to a plane of the page in FIG. 5. In this example, the offset O is sixty degrees.

Coolant C that is flowing downward between the cells 46 of the cell stack 42 (FIG. 7) is guided toward one of the outboard sides 66 when contacting the first ribs 82, and is then directed toward the other of the outboard sides 66 when contacting the second ribs 86. This introduces turbulence into the flow, which can facilitate a transfer of thermal energy.

In the exemplary embodiment, the cells 46 each include outer cases 90, which are a metal or metal alloy. The first ribs 82 are attached to the outer case 90 of one of the cells 46. The second ribs 86 are attached to the outer case 90 of an axially adjacent cells 46. The first ribs 82 and the second ribs 86 are a polymer-based material. Between each of the cells 46, first ribs 82 are can be compressed against second ribs 86 to provide one of the latticed spacers 78.

In the example latticed spacers 78, the first ribs 82 and the second ribs 86 are compressed against, but not directly connected to each other. In other examples, the first ribs 82 and the second ribs 86 are connected to each other at crossing points P, but not connected to the outer cases 90. In such as example, the latticed spacers 78 could be created from joining first ribs 82 to second ribs 86 and then inserted into an installed position between axially adjacent cells 46 within the cell stack 42.

In still other examples, the first ribs 82 and the second ribs 86 are connected to each other at crossing points P, and are additionally connected to outer cases 90 when installed within the cell stack 42.

The battery cells 46 of the example battery pack 14 each include a pair of terminals 94 (positive and negative) and a vent 98. The first ribs 82 and the second ribs 86 can be secured to the outer case 90 prior to assembling the cell stack 42. During assembly, alternating cells 46 along the axis A can be rotated about a vertically extending axis to establish the latticed spacers 78.

Features of disclosed examples include a system that provides space for flow between cells, and that guides flow moving between cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack within an interior of an enclosure, the cell stack including a plurality of battery cells disposed along a cell stack axis; and
a lattice system that guides a liquid coolant of an immersion thermal management system within the interior.

2. The assembly of claim 1, wherein the lattice system includes at least one latticed spacer that is secured directly to at least one of the battery cells.

3. The assembly of claim 1, wherein the lattice system includes at least one latticed spacer that is disposed between axially adjacent battery cells of the cell stack.

4. The assembly of claim 1, wherein the lattice system includes a plurality of latticed spacers, the cell stack including battery cells alternating with the latticed spacers along the cell stack axis.

5. The assembly of claim 1, wherein the lattice system includes at least one latticed spacer having a plurality of first ribs overlaying a plurality of second ribs.

6. The assembly of claim 5, wherein cell stack has a top side, opposing outboard sides, and a bottom side, the plurality of first ribs tilted at a first angle to guide the liquid coolant toward one of the outboard sides, the second ribs tilted at a different, second angle to guide the liquid coolant toward the other one of the outboard sides.

7. The assembly of claim 5, wherein each first rib extends along a respective first rib axis, wherein each second rib extends along a respective second rib axis, the first rib axes offset from the second rib axes about the cell stack axis.

8. The assembly of claim 7, wherein the first rib axes are offset sixty degrees from the second rib axes.

9. The assembly of claim 5, wherein the first ribs are secured directly to a first battery cell within the plurality of battery cells, wherein the second ribs are secured directly to a second battery cell within the plurality of battery cells, the first battery cell directly adjacent to the second battery cell along the cell stack axis.

10. The assembly of claim 9, wherein the first ribs and the second ribs are compressed against each other along the cell stack axis.

11. The assembly of claim 9, wherein the first ribs and the second ribs are a polymer-based material.

12. The assembly of claim 5, wherein the plurality of first ribs are directly secured to the plurality of second ribs.

13. The assembly of claim 1, wherein the lattice system is configured to guide the liquid coolant at a position between axially adjacent battery cells within the plurality of battery cells.

14. The assembly of claim 1, wherein the lattice system includes a least one latticed spacer that is polymer-based.

15. The assembly of claim 1, wherein the cell stack is one of a plurality of cell stacks within the interior.

16. The assembly of claim 1, wherein the liquid coolant is a dielectric liquid coolant.

17. A method of managing thermal energy levels within a traction battery pack, comprising:
immersing at least a portion of a cell stack within a liquid coolant to manage thermal energy within the cell stack, the cell stack including a plurality of battery cells disposed along a cell stack axis; and
guiding the liquid coolant between battery cells of the cell stack.

18. The method of claim 17, further comprising guiding the liquid coolant using at least one latticed spacer disposed axially between a first cell within the plurality of battery cells and an axially adjacent second cell within the plurality of battery cells.

19. The method of claim 18, wherein the cell stack including battery cells alternating with the latticed spacers along the cell stack axis.

20. The method of claim 17, wherein the cell stack has an top side and opposing outboard sides, the liquid coolant introduced to areas between the plurality of battery cells through the top side, the liquid coolant guided within the areas toward one of the opposing outboard sides.
